(19) United States
(12) Patent Application Publication
(10) Pub. No.: US 2026/0025796 A1
(43) Pub. Date: Jan. 22, 2026

(54) PAGING CARRIER DETERMINATION

(71) Applicant: Lenovo (Beijing) Limited, Beijing (CN)

(72) Inventors: Zhi Yan, Beijing (CN); Hongmei Liu, Beijing (CN); Yuantao Zhang, Beijing (CN); Yingying Li, Beijing (CN); Ran Yue, Beijing (CN); Haiming Wang, Beijing (CN)

(73) Assignee: Lenovo (Beijing) Limited, Beijing (CN)

(21) Appl. No.: 18/993,763

(22) PCT Filed: Jul. 14, 2022
(86) PCT No.: PCT/CN2022/105724

§ 371 Date: Jan. 13, 2025

(51) Int. Cl. H04W 68/02; H04W 52/02; H04W 76/27; H04W 76/28

(52) U.S. Cl. CPC H04W 68/02; H04W 52/0212; H04W 76/27; H04W 76/28

(57) ABSTRACT

Methods and apparatuses for paging carrier determination for NR are disclosed. A UE comprises a processor; and a transceiver coupled to the processor, wherein the processor is configured to receive, via the transceiver, a configuration of one or more carriers, wherein the configuration of each carrier includes at least one of paging search space, a carrier paging weight, a carrier DRX cycle, the number of paging frames within the DRX cycle, the number of paging occasions within one paging frame, the number of monitoring paging occasions for each SSB, transmission beam ON/OFF indication, and antenna port QCL type with anchor carrier; and determine a paging carrier from a paging carrier set including at least one of the one or more carriers according to the configuration.

### FIELD

The subject matter disclosed herein generally relates to wireless communications, and more particularly relates to methods and apparatuses for paging carrier determination for NR from multiple carriers, e.g. paging carrier determination on non-anchor carriers and/or anchor carrier.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Synchronization Signal Block (SSB), Synchronization Signal (SS), Physical Broadcast Channel (PBCH), Channel State Information Reference Signal (CSI-RS), Demodulation Reference Signal (DMRS), System Information Block (SIB), component carrier (CC), energy saving(ES), Control Resource set (CORESET), Discontinuous Reception (DRX), paging frame (PF), paging occasion (PO), Quasi Co-Location (QCL), Physical Downlink Control Channel (PDCCH), Downlink Control Information (DCI), System Frame Number (SFN), International Mobile Subscriber Identity (IMSI), Temporary Mobile Subscriber Identity (TMSI), Internet of Things (IoT), Narrow Band Internet of Things (NBIoT or NB-IoT).

For NR, anchor carrier is a carrier where UE assumes the SSB and/or SIB are transmitted. When there is already a first carrier (e.g. anchor carrier) for a UE to be able to receive SSB and/or SIB (e.g. SIB1), the common signals (e.g., SSB and/or SIB) for other carriers may be simplified and/or assisted by the signals received from the first carrier. Incidentally, a carrier may be represented by CC (component carrier). As shown in FIG. 1 for ES CC (SSB/DRS without SIB), since the SIB can be transmitted in the anchor carrier, the SIB can be not transmitted in ES CC. In addition, the period to transmit SSB in ES CC can be enlarged for energy saving. If the base station (BS) can maintain the synchronization between different CCs, the SSB on ES CC (e.g. ES CC (SSB-less & SIB-less) in FIG. 1) can be completely skipped, i.e. SSB-less, achieving additional sleeping time. The UE on ES CC can acquire time and synchronization based on the SSB on anchor CC. Both ES CC (SSB/DRS without SIB) and ES CC (SSB-less & SIB-less) shown in FIG. 1 can be referred to as non-anchor carrier.

UE can be configured to monitor paging message on anchor carriers or non-anchor carriers (e.g. there is reduced SSB or SSB-less in non-anchor carriers). The carrier on which the UE monitors or receives paging message is referred to as paging carrier.

In NR, the UE may use Discontinuous Reception (DRX) in RRC_IDLE state or RRC_INACTIVE state in order to reduce power consumption. The UE monitors one paging occasion (PO) per DRX cycle. A PO is a set of PDCCH monitoring occasions and can consist of multiple time slots (e.g. subframe or OFDM symbol) where paging DCI can be sent. One Paging Frame (PF) is one radio frame and may contain one or multiple POs or starting point of a PO.

The DRX cycle of the UE (i.e. T) is determined by the shortest of the UE-specific DRX cycle (e.g. Tue, if it is allocated by upper layers) and a default DRX value (e.g. Tc) broadcasted in system information. For example, if Tc=128 (in unit of subframes), and Tue=32, then T=min (Tc, Tue)=min (128, 32)=32.

N represents the number of PFs within one DRX cycle. N is a configured number.

Ns represents the number of POs within each PF. Ns is a configured number.

The paging frame (PF) for a particular UE (represented by UE_ID) is given by (SFN+PF_offset) mod T=(T div N)*(UE_ID mod N), where PF_offset is offset used for PF determination, and UE_ID is given by IMSI (or 5G-S-TMSI) mod 1024. For example, if IMSI=404685505601234, UE_ID=404685505601234 mod 1024=722.

The paging occasion (PO) for the particular UE (represented by UE_ID) is indicated by an index i_s derived as follows: i_s=floor (UE_ID/N) mod Ns.

PO is not limited within a system frame, but can cross multiple (e.g. 2) system frames, which is determined by the corresponding number of beams, paging search space and CORESET. For example, as shown in FIG. 2, POO is within SFN 0 while POI is across SFN 0 and SFN 1.

In 3GPP TS38.304, a PO is a set of ‘S*X’ consecutive PDCCH monitoring occasions (MOs), where ‘S’ is the number of actual transmitted SSBs determined according to ssb-PositionsInBurst in SIB1 and ‘X’ is the nrofPDCCH-MonitoringOccasionPerSSB-InPO if configured or is equal to 1 otherwise. In multi-beam operations in NR, the UE assumes that the same paging message and the same Short Message are repeated in all transmitted beams and thus the selection of the beam(s) for the reception of the paging message and short message is up to UE implementation. Each transmitted beam is associated with the SSB or CSI RS, and can be configured as ON (i.e. being used) or OFF (i.e. being unused).

FIG. 3 illustrates an example of the PO determination. In FIG. 3, it is assumed that Tc=128, Tue=32, N=32, Ns=4, IMSI (for the UE)=404685505601234. So, the DRX cycle T=min (Tc, Tue)=min (128, 32)=32; UE_ID=404685505601234 mod 1024=722; PF (for the UE)=(SFN+PF_offset) mod T=(T div N)*(UE_ID mod N)=(32 div 32)*(722 mod 32)=1*18=18; PO (for the UE)=floor (UE_ID/N) mod Ns=18 mod 4=2. So, in each DRX cycle (T), there are N=32 PFs and 32*4=128 POs (each PF with 4 POs). For a UE (with IMSI=404685505601234), every 32 frames (i.e. DRX cycle T) starting from frame #18, the UE monitors PO #2 (among POs #0, #1, #2 and #3) as the MO. It means that the UE will wake up every T=32×10=320 ms to monitor paging message in the MO.

FIG. 4 illustrates another example of the PO determination. In FIG. 4, it is assumed that Tc=128, Tue=64, N=32, Ns=4, IMSI (for the UE)=404685505601234. That is, only the Tue (=64) is different from the above example shown in FIG. 3. So, the DRX cycle T=min (Tc, Tue)=min (128, 64)=64; UE_ID=404685505601234 mod 1024=722; PF (for the UE)=(SFN+PF_offset) mod T=(T div N)*(UE_ID mod N)=(64 div 32)*(722 mod 32)=2*18=36; PO (for the UE)=floor (UE_ID/N) mod Ns=18 mod 4=2. So, in each DRX cycle (T), there are N=64 PFs and 64*4=256 POs (each PF with 4 POs). For a UE (with IMSI=404685505601234), every 36 frames (i.e. DRX cycle T) starting from frame #36, the UE monitors PO #2 (among POs #0, #1, #2 and #3) as the MO. It means that the UE will wake up every T=64×10=640 ms to monitor paging message in the MO.

It can be seen from the above two examples shown in FIGS. 3 and 4, for single carrier case, if Tc=128, Tue1=32 (in example of FIG. 3) and Tue2-64 (in example of FIG. 4), the monitoring PFs and POs are different, which means gNB can't easily multiplex the two separate paging messages in a paging message. It will waste gNB power.

For paging carrier determination in Release 14 NBIOT, carrier #1 to carrier #Nn-1 are configured as non-anchor carriers for paging in broadcast information. A paging weight can be configured for each carrier. For example, W(n) is the weight for carrier #n. W is the total weight of all carriers, that is, W=W(0)+W (1)+ . . . +W (Nn-1), where W(0) is the paging weight for carrier #0 (i.e. anchor carrier). In particular, if paging configuration (e.g. paging weight) for non-anchor carrier is provided in system information, then the paging carrier is determined by the paging carrier with smallest index n (0≤n≤Nn-1) fulfilling the equation: floor (UE_ID/(N*Ns) mod W<W(0)+W (1)+ . . . +W(n), where UE_ID is given by IMSI mod 1024; N represents the number of PFs within one DRX cycle; Ns represents the number of POs within each PF.

For example, if Nn=5 and the paging weight for each carrier is configured as W (0)=1.W (1)=2.W (2)=3.W (3)=1 and W (4)=1, then W=W(0)+W (1)+ . . . +W (4)=8. Depending on different UE_IDs, floor (UE_ID/(N*Ns)) mod W will be equal to any of 0 to 7. W (0)=1.W (0)+W (1)=3.W (0)+W (1)+W (2)=6.W (0)+W (1)+W (2)+W (3)=7, W(0)+W (1)+W (2)+W (3)+W (4)=8. So, the paging carrier is determined as indicated in Table 1:

TABLE 1

| | smallest W(0) + | |
|---|---|---|
| | W(1) + . . . + W(n) | |
| floor(UE_ID/ | that is larger than | |
| (N*Ns)) mod W | floor(UE_ID/(N*Ns)) | n |
| 0 | 1 | 0 |
| 1 | 3 | 1 |
| 2 | 3 | 1 |
| 3 | 6 | 2 |
| 4 | 6 | 2 |
| 5 | 6 | 2 |
| 6 | 7 | 3 |
| 7 | 8 | 4 |

As indicated in Table 1, carrier #0 will be determined for the UE_IDs fulfilling floor (UE_ID/(N*Ns)) mod W=0, carrier #1 will be determined for the UE_IDs fulfilling floor (UE_ID/(N*Ns)) mod W=1 or 2, carrier #2 will be determined for the UE_IDs fulfilling floor (UE_ID/(N*Ns)) mod W=3 or 4 or 5, carrier #3 will be determined for the UE IDs fulfilling floor (UE_ID/(N*Ns)) mod W=6, and carrier #4 will be determined for the UE IDs fulfilling floor (UE_ID/(N*Ns)) mod W=7.

It can be seen that due to the weight of carrier #2 (W (2)=3) which is higher than that of other carriers, the possibility of determining carrier #2 as the paging carrier is higher than the possibility of other carriers. Similarly, due to the weight of carrier #1 (W (1)=2) which is higher than that of the remaining carriers (carrier #0, carrier #3 and carrier #4), the possibility of determining carrier #1 as the paging carrier is higher than the possibility of the remaining carriers.

However, for paging carrier determination in NR, it is not enough that only paging weight (which are configured by SIBs for different carriers) is considered. For example, load balance (e.g. between the anchor and non-anchor carrier, and/or between legacy NR Release 17 UE and NR Release 18 UE) is not considered in the above-described paging weight configuration. In addition, the paging carrier for a UE is fixed based on its UE_ID. So, some UEs may be assigned with a “bad carrier” just based on their UE_ID

This invention targets determining page carrier for UEs in NR.

### BRIEF SUMMARY

Methods and apparatuses for paging carrier determination for NR are disclosed.

In one embodiment, a UE comprises a processor; and a transceiver coupled to the processor, wherein the processor is configured to) receive, via the transceiver, a configuration of one or more carriers, wherein the configuration of each carrier includes at least one of paging search space, a carrier paging weight, a carrier DRX cycle, the number of paging frames within the DRX cycle, the number of paging occasions within one paging frame, the number of monitoring paging occasions for each SSB, transmission beam ON/OFF indication, and antenna port QCL type with anchor carrier; and determine a paging carrier from a paging carrier set including at least one of the one or more carriers according to the configuration.

In some embodiment, the processor is further configured to monitor or receive, via the transceiver, a paging message on the paging carrier.

In some embodiment, the paging carrier is determined according to the carrier paging weight or the carrier DRX cycle or a UE-specific DRX cycle, or combination thereof.

In some embodiment, the paging carrier is determined according to the carrier paging weight or the carrier frequency position, or combination thereof.

In some embodiment, the paging carrier is determined by a reference time. In particular, the reference time is a subframe number or system number of the start or end of paging frame or paging occasion or monitoring occasion, or subframe number or system number when the UE switches to idle mode or receives the RRC release information.

In some embodiment, the paging carrier set is configured by higher layer.

In some embodiment, the paging carrier set is determined according to the carrier DRX cycle or the number of paging frames within the DRX cycle, or the number of monitoring paging occasions for each SSB of one or more carriers, or combination thereof. In particular, the paging carrier set includes carrier(s), each of which has a carrier DRX cycle equal to or larger than or smaller than a UE specific DRX cycle or the carrier DRX cycle of the anchor carrier, or combination thereof. Alternatively, the one or more carriers are divided into multiple paging candidate carrier sets according to DRX cycle threshold(s), and the candidate paging carrier set including a UE-specific DRX cycle or carrier DRX cycle of the anchor carrier is determined as the paging carrier set.

In some embodiment, the paging carrier set includes carrier(s), for each of which UE preferred beam is indicated as transmission ON. The UE preferred beam may be reported by UE or be associated with beam used in RACH procedure.

In some embodiment, the paging carrier set includes carrier(s), each of which is antenna port QCLed with that of anchor carrier with respect to QCL type A or QCL type B.

In one embodiment, a method at a UE comprises receiving a configuration of one or more carriers, wherein the configuration of each carrier includes at least one of paging search space, a carrier paging weight, a carrier DRX cycle, the number of paging frames within the DRX cycle, the number of paging occasions within one paging frame, the number of monitoring paging occasions for each SSB, transmission beam ON/OFF indication, and antenna port QCL type with anchor carrier; and determining a paging carrier from a paging carrier set including at least one of the one or more carriers according to the configuration

In another embodiment, a base unit comprises a processor; and a transceiver coupled to the processor, wherein the processor is configured to transmit, via the transceiver, a configuration of one or more carriers, wherein the configuration of each carrier includes at least one of paging search space, a carrier paging weight, a carrier DRX cycle, the number of paging frames within the DRX cycle, the number of paging occasions within one paging frame, the number of monitoring paging occasions for each SSB, transmission beam ON/OFF indication, and antenna port QCL type with anchor carrier; and determine a paging carrier from a paging carrier set including at least one of the one or more carriers according to the configuration.

In some embodiment, the processor is further configured to transmit, via the transceiver, a paging message on the paging carrier.

In some embodiment, the paging carrier is determined according to the carrier paging weight or the carrier DRX cycle or a UE-specific DRX cycle, or combination thereof.

In some embodiment, the paging carrier is determined according to the carrier paging weight or the carrier frequency position, or combination thereof.

In some embodiment, the paging carrier is determined by a reference time. In particular, the reference time is a subframe number or system number of the start or end of paging frame or paging occasion or monitoring occasion, or subframe number or system number when the UE switches to idle mode or receives the RRC release information.

In some embodiment, the paging carrier set is configured by higher layer.

In some embodiment, the paging carrier set is determined according to the carrier DRX cycle or the number of paging frames within the DRX cycle, or the number of monitoring paging occasions for each SSB of one or more carriers, or combination thereof. In particular, the paging carrier set includes carrier(s), each of which has a carrier DRX cycle equal to or larger than or smaller than a UE specific DRX cycle or the carrier DRX cycle of the anchor carrier, or combination thereof. Alternatively, the one or more carriers are divided into multiple paging candidate carrier sets according to DRX cycle threshold(s), and the candidate paging carrier set including a UE-specific DRX cycle or carrier DRX cycle of the anchor carrier is determined as the paging carrier set.

In some embodiment, the paging carrier set includes carrier(s), for each of which UE preferred beam is indicated as transmission ON. The UE preferred beam may be reported by UE or be associated with beam used in RACH procedure.

In some embodiment, the paging carrier set includes carrier(s), each of which is antenna port QCLed with that of anchor carrier with respect to QCL type A or QCL type B.

In yet another embodiment, a method at a base unit comprises transmitting a configuration of one or more carriers, wherein the configuration of each carrier includes at least one of paging search space, a carrier paging weight, a carrier DRX cycle, the number of paging frames within the DRX cycle, the number of paging occasions within one paging frame, the number of monitoring paging occasions for each SSB, transmission beam ON/OFF indication, and antenna port QCL type with anchor carrier; and determining a paging carrier from a paging carrier set including at least one of the one or more carriers according to the configuration.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates anchor carrier and non-anchor carriers;

FIG. 2 illustrates examples of POs;

FIG. 3 illustrates an example of the PO determination;

FIG. 4 illustrates another example of the PO determination;

FIG. 5 illustrates a principle of the first embodiment;

FIG. 6 illustrates an example of the second embodiment;

FIG. 7 is a schematic flow chart diagram illustrating an embodiment of a method;

FIG. 8 is a schematic flow chart diagram illustrating another embodiment of a method; and

FIG. 9 is a schematic block diagram illustrating apparatuses according to one embodiment.

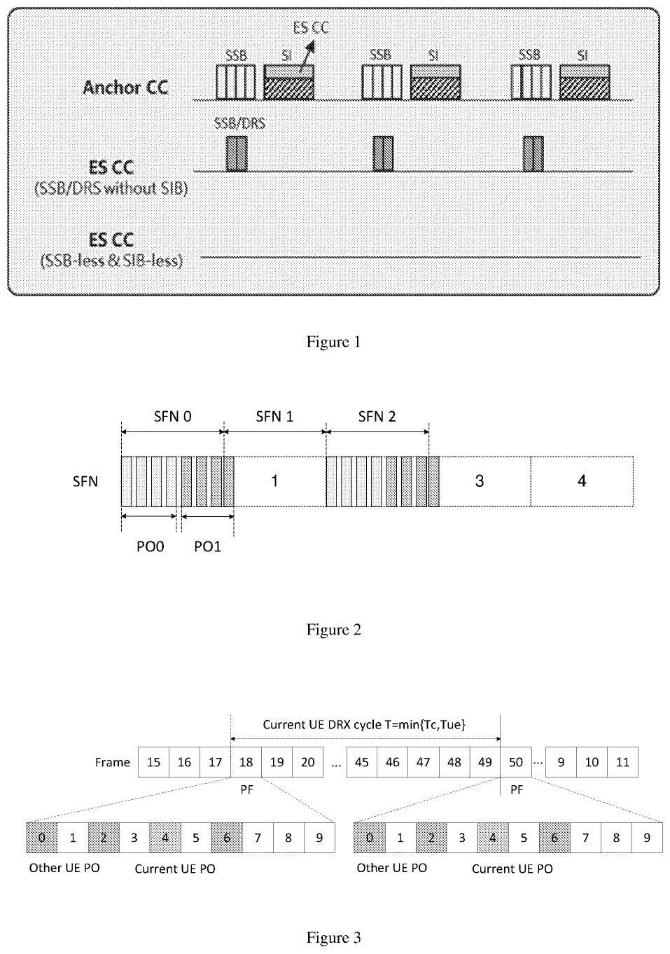

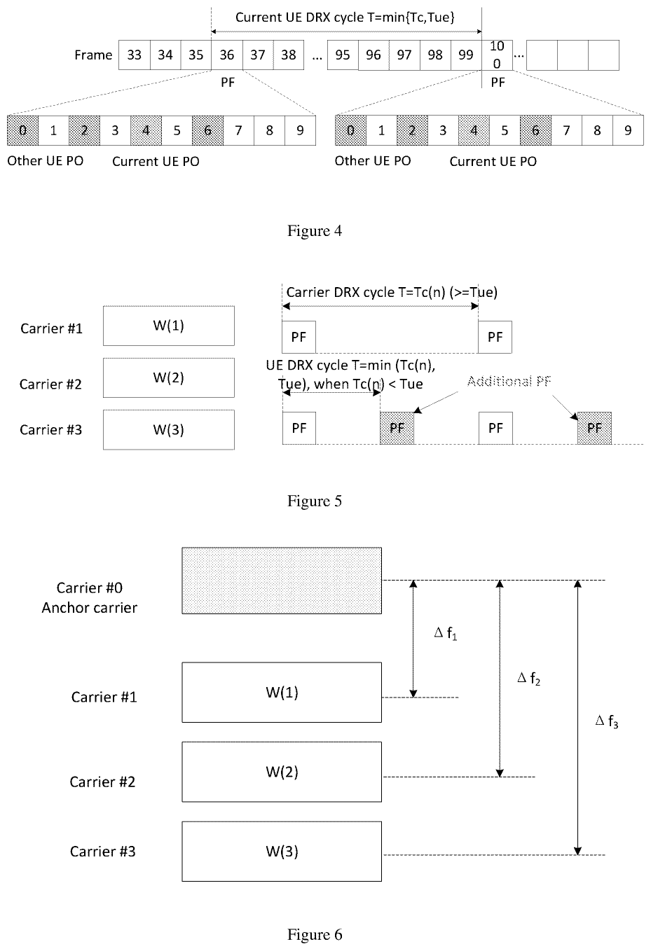

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

For paging, UE is configured with multiple non-anchor carriers in addition to an anchor carrier.

For ease of discussion, the anchor carrier is referred to as carrier #0, while each of the non-anchor carriers is referred to as carrier #n, where n is from 1 to Nn-1. In other words, UE is configured with a total number of Nn carriers, including 1 anchor carrier (carrier #0) and Nn-1 non-anchor carriers (carriers #1 to #Nn-1).

The configuration of each carrier (including anchor carrier and non-anchor carrier)

e.g. carrier (n) (or carrier C(n)), includes at least one of the following:
(1) paging search space (e.g. CORESET, period, aggregation level);
(2) carrier paging weight: W(n);
(3) Carrier specific DRX cycle (or carrier DRX cycle): Tc(n);
(4) the number of PFs within one DRX cycle: N(n);
(5) the number of POs within each PF: Ns(n);
(6) the number of monitoring MOs for each SSB;
(7) beam ON/OFF information per carrier #n; and
(8) antenna port QCL type of the carrier #n with the anchor carrier (i.e. carrier #0): QCL(n).

In addition, UE is configured with UE-specific DRX cycle (e.g. Tue).

The UE receives the configuration of each carrier and determines a paging carrier for the UE according to the configuration of each carrier. After the paging carrier is determined, the UE monitors or receives paging message on the paging carrier. For example, if paging message is transmitted on the paging carrier from the gNB, the UE can receive the paging message on a specific PO for the UE on the paging carrier.

According to a first embodiment, UE determines the paging carrier based on carrier paging weight W(n), carrier DRX cycle (Tc(n)) and UE-specific DRX cycle (Tue).

The first embodiment is made in consideration that, if a carrier has more PFs (e.g. with shorter carrier DRX cycle) or more POs or more physical resources for PDCCH (CORESETs) for each PO (or for MO), the carrier shall be configured with more weight to be determined as the paging carrier, which reflects more potential paging resource for paging. For example, as shown in FIG. 5, for each of carriers #1 to #3 listed in the left part, the carrier DRX cycle (Tc(n)) may be larger than or equal to UE-specific DRX cycle (Tue) (upper right part), or smaller than Tue (lower right part). It can be seen that, since the number of PFs is defined within a DRX cycle, due to smaller Tc(n), more PFs exist (shown in lower right part of FIG. 5) in a time duration. So, the carrier DRX cycle and the UE-specific DRX cycle can be further considered in the paging weight of each carrier.

According to the first embodiment, a UE specific paging weight V(n) is defined as V(n)=W(n)*max(1, Tc(n)/Tue), where W(n) is carrier paging weight, Tc(n) is carrier DRX cycle, and Tue is UE-specific DRX cycle.

If UE-specific DRX cycle (Tue) is larger than carrier DRX cycle, then (Tc(n)), max(1, Tc(n)/Tue)=1, i.e. V(n)=W(n).

The paging carrier is determined by the paging carrier with smallest index n (0≤ n≤Nn-1) fulfilling the equation: floor (UE_ID/(N*Ns)) mod V<V (0)+V (1)+ . . . +V(n), where, if V(n) is an integer (which means that V(n)=round (W(n)*max(1, Tc(n)/Tue))), V=sum (V(n)), 0≤n≤Nn-1; and if V(n) can be not an integer, V=round (sum (V(i)).

According to a second embodiment, UE further determines the paging carrier based on carrier paging weight W(n) and the frequency position of the carrier (e.g. non-anchor carrier). The paging weight W(n) reflects the paging load on each carrier #n. According to the second embodiment, the frequency position of the carrier #n adds priority to the paging weight W(n).

For example, the non-anchor carrier that is closer to the anchor carrier has a higher priority or possibility to be determined as the paging carrier. For another example, the non-anchor carrier that is intra carrier of the anchor carrier has a higher possibility to be determined as the paging carrier than the non-anchor carrier that is inter-carrier of the anchor carrier

In particular, each non-anchor carrier is configured with a frequency position weight Z(n) according to its frequency position (e.g. offset) relative to the anchor carrier. The closer to the anchor carrier, the frequency position weight is higher. Incidentally, it is supposed that the anchor carrier has a higher frequency position weight than any other non-anchor carriers. For example, if it is supposed that there are four carriers configured to UE including one anchor carrier and three non-anchor carriers, the frequency position weight Z(0) of the anchor carrier can be configured as 4, while the frequency position weight Z(n)(Z(1), Z(2) and Z(3)) may be configured as 3, 2 and 1 by higher layer signaling, respectively, depending on reverse order of their frequency offsets to the anchor carrier. For example, as shown in FIG. 6, carrier #1 is the closest carrier to the anchor carrier, carrier #2 is the second closest carrier to the anchor carrier, and carrier #3 is the least closest carrier to the anchor carrier (i.e. Δf₁<Δf₂<Δf₃).

According to the second embodiment, the paging carrier is determined by the paging carrier with smallest index n (0≤n≤Nn-1) fulfilling the equation: floor (UE_ID/(N*Ns)) mod (W*Z)<W(0)*Z (0)+W (1)*Z (1)+ . . . +W(n)*Z(n), where W*Z=sum (W(n)*Z(n)). It is supposed that W*Z is an integer.

According to a third embodiment, UE further determines the paging carrier further based on a reference time.

The reference time can be the subframe number (or SFN) (1) when UE switches to idle mode or (2) when UE receives RRC release information or (3) of the start or end of a PF or a PO or a MO. The PF may be the current PF of the current carrier, or the last PF of the current carrier. The PO may be the PO of the current PF, or the PO the last PF.

According to the third embodiment, the paging carrier is determined by the paging carrier with smallest index n (0≤n≤Nn-1) fulfilling the equation: floor (UE_ID/(N*Ns)+SFN) mod W<W(0)+W (1)+ . . . +W(n), where SFN represents the reference time.

When the SFN is considered, the same UE (with the same UE_ID) will not always be configured with the same paging carrier.

According to a fourth embodiment, a paging carrier subset is determined.

The motivation of the fourth embodiment is to divide the carriers into multiple carrier subsets and distribute the UE to different carrier subsets, which can facilitate UE paging message multiplexing and save network energy. For example, if UEs with similar or same configuration (e.g. Tc, N and/or Ns) are multiplexed in one paging message, the gNB can decrease the number of transmissions of paging messages for saving energy.

In the above-described first to third embodiments, all configured carriers (including the anchor carrier and/or all non-anchor carriers) can be determined as the paging carrier. According to the fourth embodiment, a paging carrier subset is determined from the configured carriers (including the anchor carrier and all non-anchor carriers). Only the carrier belonging to the paging carrier subset can be determined as the paging carrier.

In the following sub-embodiments of the fourth embodiment, one or multiple carriers are selected to be contained in the paging carrier subset. Each carrier is a carrier that is configured to be a candidate paging carrier. For example, each carrier can be an anchor carrier or a non-anchor carrier. Incidentally, the anchor carrier may not be considered in each sub-embodiment. It means that the paging carrier subset only includes one or multiple non-anchor carriers. Alternatively, after the paging carrier subset including only non-anchor carrier(s) is determined, the anchor carrier is further added into the paging carrier subset.

According to a first sub-embodiment of the fourth embodiment, the paging carrier subset is determined according to a reference DRX cycle.

The reference DRX cycle can be UE-specific DRX cycle (Tue).

Alternatively, if the UE-specific DRX cycle (Tue) is not configured, the cell specific DRX cycle in anchor carrier (Tc(0)) is assumed to be the reference DRX cycle.

According to the first sub-embodiment of the fourth embodiment, all carriers (e.g. non-anchor carriers) having a carrier DRX cycle Tc(n) not smaller (i.e. equal to or larger than) the reference DRX cycle belong to the paging carrier subset.

For example, UE is configured with UE-specific DRX cycle (Tue) of 64, as the reference DRX cycle. UE is configured with 4 carriers C(n) with carrier DRX cycle Tc(n) of 32, 64, 64 and 128, respectively. So, the paging carrier subset consists of C(2), C(3) and C(4), each of which has a carrier DRX cycle not smaller than Tue (64). C(1) that has a carrier DRX cycle (32) smaller than the reference DRX cycle (64) is not included in the paging carrier subset.

According to a variety of the first sub-embodiment of the fourth embodiment, the carriers (e.g. non-anchor carriers) are divided into multiple (e.g. 2) candidate paging carrier subsets based on one or more thresholds (e.g. each threshold is a DRX cycle), and the candidate paging carrier subset including the reference DRX cycle is selected as the paging carrier subset.

For example, UE is configured with UE-specific DRX cycle (Tue) of 64, as the reference DRX cycle. UE is configured with 4 carriers C(n) with carrier DRX cycle Tc(n) of 32, 64, 64 and 128, respectively. Suppose that the threshold to divide the carrier subsets is 64, the 4 non-anchor carriers C(n) are divided into 2 candidate paging carrier subsets: one candidate paging carrier subset including the carrier(s) with the carrier DRX cycle(s) Tc(n) smaller than the threshold, i.e. including C(1), and the other candidate paging carrier subset including the carriers with the carrier DRX cycle(s) Tc(n) equal to or larger than the threshold, i.e. including C(2), C(3) and C(4). The other candidate paging carrier subset (consisting of C(2), C(3) and C(4)) including the reference DRX cycle (64) is selected as the paging carrier subset.

According to a further variety of the first sub-embodiment of the fourth embodiment, the paging carrier subset consists of only the carrier(s) with the carrier DRX cycle(s) Tc(n) equal to the reference DRX cycle.

For example, UE is configured with UE-specific DRX cycle (Tue) of 64, as the reference DRX cycle. UE is configured with 4 carriers C(n) with carrier DRX cycle Tc(n) of 32, 64, 64 and 128, respectively. So, the paging carrier subset consists of C(2) and C(3), each of which has the carrier DRX cycle Tc(n) equal to the reference DRX cycle.

According to the first sub-embodiment of the fourth embodiment, the parameter to be compared with the reference DRX cycle is the carrier DRX cycle. Within each carrier DRX cycle, a UE monitors one PO, where N represents the number of PFs within one DRX cycle and Ns represents the number of POs within each PF. So, the carrier DRX cycle is related to the number of PFs within one DRX cycle (i.e. N) and the number of POs within each PF (i.e. Ns). According to a second sub-embodiment of the fourth embodiment, the DRX cycle can be replaced by the number of PFs within one DRX cycle (i.e. N) and/or the number of POs within each PF (i.e. Ns).

For a first example, the reference to determine the paging carrier subset may be a reference number of PFs within one DRX cycle (i.e. N_{reference}), while a configured number of PFs within one DRX cycle for each non-anchor carrier (N(n)) is compared with the reference number of PFs within one DRX cycle to determine which non-anchor carrier belongs to the paging carrier subset.

For a second example, the reference to determine the paging carrier subset may be a reference number of POs within each PF (i.e. Ns_{reference}), while a configured number of POs within each PF (Ns(n)) is compared with the reference number of POs within each PF to determine which non-anchor carrier belongs to the paging carrier subset.

For a third example, the reference to determine the paging carrier subset may be a reference of a combination of the number of PFs within one DRX cycle and the number of POs within each PF (e.g. a N*Ns_{reference} which may be equal to N_{reference}*Ns_{reference}), while N(n)*Ns(n) is compared with N_{reference}*Ns_{reference} to determine which non-anchor carrier belongs to the paging carrier subset.

According to a third sub-embodiment of the fourth embodiment, the UE determines the paging carrier subset according to beam ON/OFF indication. A beam corresponds to a transmission filter that is associated with antenna port quasi co-location. The antenna port quasi co-location can be among different reference signals, e.g. SS/PBCH block (SSB), CSI-RS, DMRS, etc. In multi-beam operations in NR, the UE assumes that the same paging message and the same Short Message are repeated in all transmitted beams and thus the selection of the beam(s) for the reception of the paging message and short message is up to UE implementation. Each transmitted beam is associated with the SS/PBCH block (SSB), CSI-RS, or DMRS. A paging message beam being indicated as ON means that the corresponding transmission filter is ON, or the paging message in a transmission filter with antenna port quasi co-location properties as a SS/PBCH block or a CSI-RS resource the UE uses is assumed to be transmission ON, while a paging message beam being indicated as OFF means that the corresponding transmission filter is OFF, or the paging message in a transmission filter with antenna port quasi co-location properties as a SS/PBCH block or a CSI-RS resource the UE uses is assumed to be transmission OFF. For simplicity, we use the transmission beam ON and OFF to take the place of following UE behavior.

In particular, for UE without moving (i.e. stationary UE), the gNB may broadcast beam ON/OFF indication for each carrier. UE determines which carrier belongs to the paging carrier subset according to the preferred beam. In particular, only the carrier with the preferred beam ON belongs to the paging carrier subset. The preferred beam may be the reported beam by the UE, or the beam associated with RACH, e.g., the preferred beam may be an index value of a SS/PBCH block, where the paging message in the preferred beam with antenna port quasi co-location properties as the SS/PBCH block the UE uses.

For example, UE is configured with 4 non-anchor carriers C(n) each with eight beams (e.g. beams 0, 1, 2, 3, 4, 5, 6, 7). The beam ON/OFF indication for each carrier C(n) is:
C(1): beams ON: beams 0, 1, 2, 3, 4, 5, 6, 7 (i.e. beams OFF: none);
C(2): beams ON: beams 0, 2, 4, 6 (i.e. beams OFF: beams 1, 3, 5, 7);
C(3): beams ON: beams 1, 3, 5, 7 (i.e. beams OFF: beams 0, 2, 4, 6); and
C(4): beams ON: beams 0, 1, 2, 3, 4, 5, 6, 7 (i.e. beams OFF: none).

A UE without moving reports its preferred beam is beam 2. So, the paging carrier subset consists of C(1), C(2) and C(4), for each of which beam 2 is ON.

On the other hand, for UEs without any preferred beam, the paging carrier subset consists of C(1) and C(4) where all beams should be ON for UEs without any preferred beam.

According to a fourth sub-embodiment of the fourth embodiment, the UE determines the paging carrier subset according to the QCL assumption between the non-anchor carrier and the anchor carrier. In particular, all non-anchor carriers that are QCLed with the anchor carrier with respect to QCL-Type A or QCL-Type B belong to the paging carrier subset, where QCL-Type A: {Doppler shift, Doppler spread, average delay, delay spread}; and QCL-Type B: {Doppler shift, Doppler spread}.

If a non-anchor carrier is QCLed with the anchor carrier with respect to QCL-Type A, the Doppler shift, Doppler spread, average delay and delay spread for the non-anchor carrier can be obtained from the Doppler shift, Doppler spread, average delay and delay spread for the anchor carrier. If a non-anchor carrier is QCLed with the anchor carrier with respect to QCL-Type B, the Doppler shift, Doppler spread for the non-anchor carrier can be obtained from the Doppler shift, Doppler spread.

According to a fifth sub-embodiment of the fourth embodiment, paging candidate carrier subsets can be configured by higher layer signaling. UE can select a paging carrier set from the multiple configured paging candidate carrier sets based on parameter(s) of the carriers included in the multiple configured paging candidate carrier sets. For example, each carrier contained in the multiple configured paging candidate carrier sets has a DRX cycle. A UE may determine the paging candidate carrier set that includes a carrier having a DRX cycle that is the same as UE specific DRX cycle of the UE.

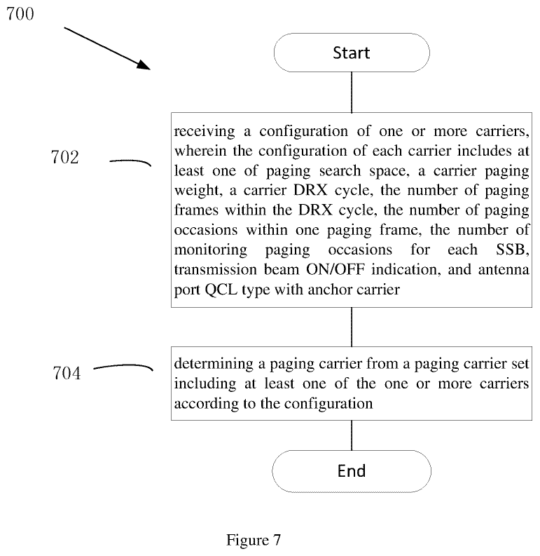

FIG. 7 is a schematic flow chart diagram illustrating an embodiment of a method 700 according to the present application. In some embodiments, the method 700 is performed by an apparatus, such as a remote unit (UE). In certain embodiments, the method 700 may be performed by a processor executing program code, for example, a microcontroller, a microprocessor, a CPU, a GPU, an auxiliary processing unit, a FPGA, or the like.

The method 700 may comprise 702 receiving a configuration of one or more carriers, wherein the configuration of each carrier includes at least one of paging search space, a carrier paging weight, a carrier DRX cycle, the number of paging frames within the DRX cycle, the number of paging occasions within one paging frame, the number of monitoring paging occasions for each SSB, transmission beam ON/OFF indication, and antenna port QCL type with anchor carrier; and 704 determining a paging carrier from a paging carrier set including at least one of the one or more carriers according to the configuration.

In some embodiment, the method further comprises monitoring or receiving a paging message on the paging carrier.

In some embodiment, the paging carrier is determined according to the carrier paging weight or the carrier DRX cycle or a UE-specific DRX cycle, or combination thereof.

In some embodiment, the paging carrier is determined according to the carrier paging weight or the carrier frequency position, or combination thereof.

In some embodiment, the paging carrier is determined by a reference time. In particular, the reference time is a subframe number or system number of the start or end of paging frame or paging occasion or monitoring occasion, or subframe number or system number when the UE switches to idle mode or receives the RRC release information.

In some embodiment, the paging carrier set is configured by higher layer.

In some embodiment, the paging carrier set is determined according to the carrier DRX cycle or the number of paging frames within the DRX cycle, or the number of monitoring paging occasions for each SSB of one or more carriers, or combination thereof. In particular, the paging carrier set includes carrier(s), each of which has a carrier DRX cycle equal to or larger than or smaller than a UE specific DRX cycle or the carrier DRX cycle of the anchor carrier, or combination thereof. Alternatively, the one or more carriers are divided into multiple paging candidate carrier sets according to DRX cycle threshold(s), and the candidate paging carrier set including a UE-specific DRX cycle or carrier DRX cycle of the anchor carrier is determined as the paging carrier set.

In some embodiment, the paging carrier set includes carrier(s), for each of which UE preferred beam is indicated as transmission ON. The UE preferred beam may be reported by UE or be associated with beam used in RACH procedure.

In some embodiment, the paging carrier set includes carrier(s), each of which is antenna port QCLed with that of anchor carrier with respect to QCL type A or QCL type B.

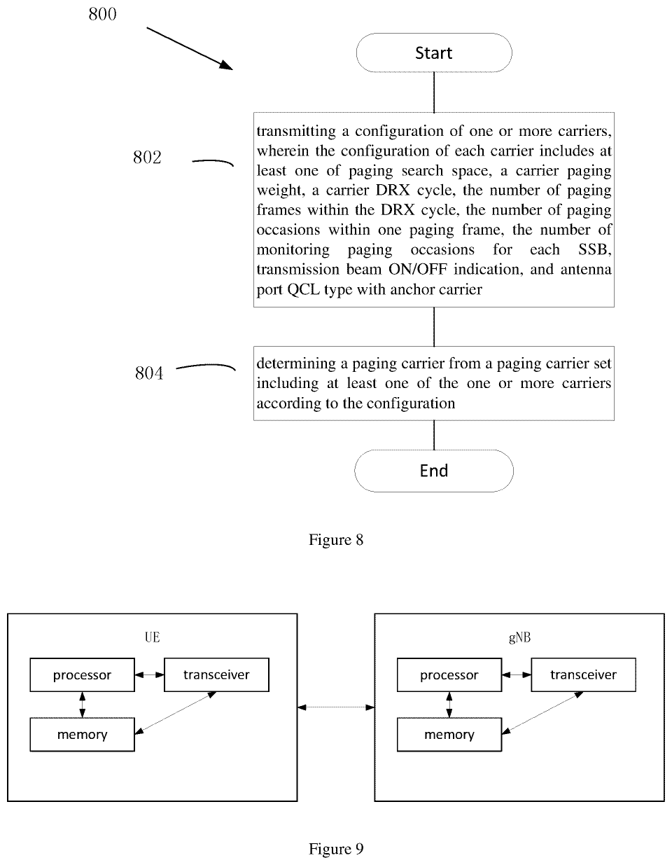

FIG. 8 is a schematic flow chart diagram illustrating a further embodiment of a method 800 according to the present application. In some embodiments, the method 800 is performed by an apparatus, such as a base unit. In certain embodiments, the method 800 may be performed by a processor executing program code, for example, a microcontroller, a microprocessor, a CPU, a GPU, an auxiliary processing unit, a FPGA, or the like.

The method 800 may comprise 802 transmitting a configuration of one or more carriers, wherein the configuration of each carrier includes at least one of paging search space, a carrier paging weight, a carrier DRX cycle, the number of paging frames within the DRX cycle, the number of paging occasions within one paging frame, the number of monitoring paging occasions for each SSB, transmission beam ON/OFF indication, and antenna port QCL type with anchor carrier; and 804 determining a paging carrier from a paging carrier set including at least one of the one or more carriers according to the configuration.

In some embodiment, the method further comprises transmitting a paging message on the paging carrier.

In some embodiment, the paging carrier is determined according to the carrier paging weight or the carrier DRX cycle or a UE-specific DRX cycle, or combination thereof.

In some embodiment, the paging carrier is determined according to the carrier paging weight or the carrier frequency position, or combination thereof.

In some embodiment, the paging carrier is determined by a reference time.

In particular, the reference time is a subframe number or system number of the start or end of paging frame or paging occasion or monitoring occasion, or subframe number or system number when the UE switches to idle mode or receives the RRC release information.

In some embodiment, the paging carrier set is configured by higher layer.

In some embodiment, the paging carrier set is determined according to the carrier DRX cycle or the number of paging frames within the DRX cycle, or the number of monitoring paging occasions for each SSB of one or more carriers, or combination thereof. In particular, the paging carrier set includes carrier(s), each of which has a carrier DRX cycle equal to or larger than or smaller than a UE specific DRX cycle or the carrier DRX cycle of the anchor carrier, or combination thereof. Alternatively, the one or more carriers are divided into multiple paging candidate carrier sets according to DRX cycle threshold(s), and the candidate paging carrier set including a UE-specific DRX cycle or carrier DRX cycle of the anchor carrier is determined as the paging carrier set.

In some embodiment, the paging carrier set includes carrier(s), for each of which UE preferred beam is indicated as transmission ON. The UE preferred beam may be reported by UE or be associated with beam used in RACH procedure.

In some embodiment, the paging carrier set includes carrier(s), each of which is antenna port QCLed with that of anchor carrier with respect to QCL type A or QCL type B.

FIG. 9 is a schematic block diagram illustrating apparatuses according to one embodiment.

Referring to FIG. 9, the UE (i.e. the remote unit) includes a processor, a memory, and a transceiver. The processor implements a function, a process, and/or a method which are proposed in FIG. 7.

The UE comprises a processor; and a transceiver coupled to the processor, wherein the processor is configured to receive, via the transceiver, a configuration of one or more carriers, wherein the configuration of each carrier includes at least one of paging search space, a carrier paging weight, a carrier DRX cycle, the number of paging frames within the DRX cycle, the number of paging occasions within one paging frame, the number of monitoring paging occasions for each SSB, transmission beam ON/OFF indication, and antenna port QCL type with anchor carrier; and determine a paging carrier from a paging carrier set including at least one of the one or more carriers according to the configuration.

In some embodiment, the processor is further configured to monitor or receive, via the transceiver, a paging message on the paging carrier.

In some embodiment, the paging carrier is determined according to the carrier paging weight or the carrier DRX cycle or a UE-specific DRX cycle, or combination thereof.

In some embodiment, the paging carrier is determined according to the carrier paging weight or the carrier frequency position, or combination thereof.

In some embodiment, the paging carrier is determined by a reference time. In particular, the reference time is a subframe number or system number of the start or end of paging frame or paging occasion or monitoring occasion, or subframe number or system number when the UE switches to idle mode or receives the RRC release information.

In some embodiment, the paging carrier set is configured by higher layer.

In some embodiment, the paging carrier set is determined according to the carrier DRX cycle or the number of paging frames within the DRX cycle, or the number of monitoring paging occasions for each SSB of one or more carriers, or combination thereof. In particular, the paging carrier set includes carrier(s), each of which has a carrier DRX cycle equal to or larger than or smaller than a UE specific DRX cycle or the carrier DRX cycle of the anchor carrier, or combination thereof. Alternatively, the one or more carriers are divided into multiple paging candidate carrier sets according to DRX cycle threshold(s), and the candidate paging carrier set including a UE-specific DRX cycle or carrier DRX cycle of the anchor carrier is determined as the paging carrier set.

In some embodiment, the paging carrier set includes carrier(s), for each of which UE preferred beam is indicated as transmission ON. The UE preferred beam may be reported by UE or be associated with beam used in RACH procedure.

In some embodiment, the paging carrier set includes carrier(s), each of which is antenna port QCLed with that of anchor carrier with respect to QCL type A or QCL type B. 25

Referring to FIG. 9, the gNB (i.e. base unit) includes a processor, a memory, and a transceiver. The processors implement a function, a process, and/or a method which are proposed in FIG. 8.

The base unit comprises a processor; and a transceiver coupled to the processor, wherein the processor is configured to transmit, via the transceiver, a configuration of one or more carriers, wherein the configuration of each carrier includes at least one of paging search space, a carrier paging weight, a carrier DRX cycle, the number of paging frames within the DRX cycle, the number of paging occasions within one paging frame, the number of monitoring paging occasions for each SSB, transmission beam ON/OFF indication, and antenna port QCL type with anchor carrier; and determine a paging carrier from a paging carrier set including at least one of the one or more carriers according to the configuration.

In some embodiment, the processor is further configured to transmit, via the transceiver, a paging message on the paging carrier.

In some embodiment, the paging carrier is determined according to the carrier paging weight or the carrier DRX cycle or a UE-specific DRX cycle, or combination thereof.

In some embodiment, the paging carrier is determined according to the carrier paging weight or the carrier frequency position, or combination thereof.

In some embodiment, the paging carrier is determined by a reference time. In particular, the reference time is a subframe number or system number of the start or end of paging frame or paging occasion or monitoring occasion, or subframe number or system number when the UE switches to idle mode or receives the RRC release information.

In some embodiment, the paging carrier set is configured by higher layer.

In some embodiment, the paging carrier set is determined according to the carrier DRX cycle or the number of paging frames within the DRX cycle, or the number of monitoring paging occasions for each SSB of one or more carriers, or combination thereof. In particular, the paging carrier set includes carrier(s), each of which has a carrier DRX cycle equal to or larger than or smaller than a UE specific DRX cycle or the carrier DRX cycle of the anchor carrier, or combination thereof. Alternatively, the one or more carriers are divided into multiple paging candidate carrier sets according to DRX cycle threshold(s), and the candidate paging carrier set including a UE-specific DRX cycle or carrier DRX cycle of the anchor carrier is determined as the paging carrier set.

In some embodiment, the paging carrier set includes carrier(s), for each of which UE preferred beam is indicated as transmission ON. The UE preferred beam may be reported by UE or be associated with beam used in RACH procedure.

In some embodiment, the paging carrier set includes carrier(s), each of which is antenna port QCLed with that of anchor carrier with respect to QCL type A or QCL type B.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

What is claimed is:

1. A user equipment (UE) for wireless communication, comprising:
at least one memory; and
at least one processor coupled with the at least one memory and configured to cause the UE to:
receive a configuration of one or more carriers, wherein the configuration of each carrier of the one or more carriers includes at least one of:
a paging search space;
a carrier paging weight;
a carrier discontinuous reception (DRX) cycle;
a number of paging frames within the carrier DRX cycle;
a number of paging occasions within one paging frame;
a number of monitoring paging occasions for each synchronization signal block (SSB);
a transmission beam ON/OFF indication; or
an antenna port quasi co-location (QCL) type with an anchor carrier; and
determine a paging carrier from a paging carrier set including at least one carrier of the one or more carriers according to the configuration.

2. The UE of claim 1, wherein, the at least one processor is further configured to cause the UE to monitor or receive a paging message on the paging carrier.

3. The UE of claim 1, wherein, the paging carrier is determined according to one or more of the carrier paging weight the carrier DRX cycle, or a UE-specific DRX cycle.

4. The UE of claim 1, wherein, the paging carrier is determined according to one or more of the carrier paging weight or a carrier frequency position.

5. The UE of claim 1, wherein, the paging carrier is determined by a reference time.

6. The UE of claim 5, wherein, the reference time comprises one or more of:
a subframe number or a system number of a start or end of one or more of a paging frame, a paging occasion, or a monitoring occasion; of
a subframe number or a system number when the UE switches to idle mode or receives radio resource control (RRC) release information.

7. The UE of claim 1, wherein, the paging carrier set is configured by a higher layer.

8. The UE of claim 1, wherein, the paging carrier set is determined according to one or more of the carrier DRX cycle, the number of paging frames within the carrier DRX cycle, or the number of monitoring paging occasions for each SSB of one or more carriers.

9. The UE of claim 8, wherein, the paging carrier set includes the one or more carriers, and each carrier of the one or more carriers has a carrier DRX cycle that is smaller than, equal to, or larger than one or more of a UE-specific DRX cycle or a carrier DRX cycle of the anchor carrier.

10. The UE of claim 8, wherein,
the one or more carriers are divided into multiple paging candidate carrier sets according to one or more DRX cycle thresholds; and
a candidate paging carrier set including a UE-specific DRX cycle or a carrier DRX cycle of the anchor carrier is determined as the paging carrier set.

11. The UE of claim 1, wherein, the paging carrier set includes the one or more carriers, and for each carrier of the one or more carriers a UE preferred beam is indicated as transmission ON.

12. The UE of claim 11, wherein, the UE preferred beam is reported by the UE or is associated with a beam used in a random access channel (RACH) procedure.

13. The UE of claim 1, wherein, the paging carrier set includes the one or more carriers, and each carrier of the one or more carriers is antenna port QCLed with the anchor carrier with respect to QCL type A or QCL type B.

14. A method performed by a user equipment (UE), the method comprising:
receiving a configuration of one or more carriers, wherein the configuration of each carrier of the one or more carriers includes at least one of:
a paging search space;
a carrier paging weight;
a carrier DRX discontinuous reception (DRX) cycle;
a number of paging frames within the carrier DRX cycle;
a number of paging occasions within one paging frame;
a number of monitoring paging occasions for each synchronization signal block (SSB);
a transmission beam ON/OFF indication; or
an antenna port quasi co-location (QCL) QCL type with an anchor carrier; and
determining a paging carrier from a paging carrier set including at least one carrier of the one or more carriers according to the configuration.

15. A base unit for wireless communication, comprising:
at least one memory; and
at least one processor coupled with the at least one memory and configured to cause the base unit to:
transmit a configuration of one or more carriers, wherein the configuration of each carrier of the one or more carriers includes at least one of:
a paging search space;
a carrier paging weight;
a carrier discontinuous reception (DRX) cycle;
a number of paging frames within the carrier DRX cycle;
a number of paging occasions within one paging frame;
a number of monitoring paging occasions for each synchronization signal block (SSB);
a transmission beam ON/OFF indication; or
an antenna port quasi co-location (QCL) QCL type with an anchor carrier; and
determine a paging carrier from a paging carrier set including at least one carrier of the one or more carriers according to the configuration.

16. A processor for wireless communication, comprising:
at least one controller coupled with at least one memory and configured to cause the processor to:
receive a configuration of one or more carriers, wherein the configuration of each carrier of the one or more carriers includes at least one of:
a paging search space;
a carrier paging weight;
a carrier discontinuous reception (DRX) cycle;
a number of paging frames within the carrier DRX cycle;
a number of paging occasions within one paging frame;
a number of monitoring paging occasions for each synchronization signal block (SSB);
a transmission beam ON/OFF indication; or
an antenna port quasi co-location (QCL) type with an anchor carrier; and
determine a paging carrier from a paging carrier set including at least one carrier of the one or more carriers according to the configuration.

17. The processor of claim 16, wherein, the at least one controller is further configured to cause the processor to monitor or receive a paging message on the paging carrier.

18. The processor of claim 16, wherein, the paging carrier is determined according to one or more of the carrier paging weight, the carrier DRX cycle, or a user equipment (UE)-specific DRX cycle.

19. The processor of claim 16, wherein, the paging carrier is determined according to one or more of the carrier paging weight or a carrier frequency position.

20. The processor of claim 16, wherein, the paging carrier is determined by a reference time.
